(19) United States
(12) Patent Application Publication
(10) Pub. No.: US 2026/0230706 A1
(43) Pub. Date: Aug. 6, 2026

(54) Method and Apparatus for the Accurate Linear Speed Measurement of Trains and The Capture of High Resolution Images of a Moving Train

(71) Applicants: EDWARD J. BUSCHELMAN, JACKSONVILLE, FL (US); JEFFREY S. M. PHILLIPS, JACKSONVILLE, FL (US); GEOFFREY S. L. BROWN, JACKSONVILLE, FL (US); MARGARET K. KERNAN, JACKSONVILLE, FL (US); MATTHEW J. KNIGHT, JACKSONVILLE, FL (US); JEFFREY R. NECCIAI, JACKSONVILLE, FL (US)

(72) Inventors: EDWARD J. BUSCHELMAN, JACKSONVILLE, FL (US); JEFFREY S. M. PHILLIPS, JACKSONVILLE, FL (US); GEOFFREY S. L. BROWN, JACKSONVILLE, FL (US); MARGARET K. KERNAN, JACKSONVILLE, FL (US); MATTHEW J. KNIGHT, JACKSONVILLE, FL (US); JEFFREY R. NECCIAI, JACKSONVILLE, FL (US)

(21) Appl. No.: 19/046,903

(22) Filed: Feb. 6, 2025

(51) Int. Cl. H04N 23/68; H04N 23/56; H04N 23/60; H04N 23/661

(52) U.S. Cl. CPC H04N 23/682; H04N 23/56; H04N 23/64; H04N 23/661

(57) ABSTRACT

The condition of the train must be constantly monitored to ensure the safety and integrity of the train. This technology enables the capture of high-resolution images of the train as it moves on the set of rails for that purpose. In order to obtain the highest resolution, proportional, and efficient processing and storage of images of the moving train as it moves through the portal, the speed of the train must be accurately measured and cameras triggered at a proportional frequency.

### BACKGROUND OF THE INVENTION

This relates to the capture of high-resolution images of a moving object at a rate proportional to the speed of the moving object. The images are used with the implementation of artificial intelligence to detect anomalies of the moving object. The application will discuss the technology in the capture of images for a moving train, but it is anticipated that this technology can be used in other applications.

The Linear Speed System is an integrational device system that calculates the speed of a moving object and utilizes a set of configuration settings to calculate a nominal frequency. The nominal frequency is then manipulated and customized within the firmware to output designated trigger frequency on a specific output channels. Separate cameras are controlled and linked to the designated trigger frequency in the specific output channel. For every new speed input to the device a new output frequency for every channel is generated, allowing for a dynamic proportional response to a change in speed.

This device initially was conceived in terms of the rail industry but can be used in a variety of commercial and industrial machine vision imaging applications. The Linear Speed System is designed to support target speeds ranging between 0 and 125 miles per hour. It is anticipated that there will be 16 output channels, although there may be a different number depending on the user specific requirements. The Linear Speed System requires a speed of the target as an input. The first criteria is to determine the speed of the moving object, in this case, a train. The target speed is measured by a single or multiple devices and these speed measurements are provided as an input following an analog or digital communication methods to computational devices at a resolution to support dynamic changes in speed of the target. The resolution at which the system can receive speed inputs is the resolution at which the system can dynamically adjust the output. This allows for the target to independently change speed and the Linear Speed System to respond proportionally.

In one embodiment, the speed measurement is calculated by the placement of wheel detection devices installed on or near the rail. The wheel detection device is not a part of this application, but its integration is identified. Each wheel detection device is comprised of two sensors a known distance apart. One example of a wheel detection device would be a device which measures the changes in the magnetic field disturbance as the wheel passes. Another example of a wheel detection device would be a laser device operating as a trip wire. In either case, each of the two sensors of the device sends a signal to the computational device. The Linear Speed System will calculate the time between the receipt each of the signals received by the 2x sensors and with the known distance between the two sensors, calculate speed. Up to five wheel detection devices can be inputted as separate input channels into a computational device of the Linear Speed System. Every set of signals received by each of the Wheel Detection devices will initiate the calculation of a new output.

In one embodiment, the speed measurement is calculated by a third party device through alternate measurement means. An example of this device is a non-contact radar or laser speed detection system which would provide a digital signal to the LSS computation device through standard protocols such as TCP/IP.

The image acquisition method determines the calculation requirement for the output or of the trigger frequency. Image acquisition methods are organized into line scan and area scan technologies. The Linear Speed System computational device provides for user configuration of each frequency output channel to a designated Line Scan or Area Scan setting. Additionally, the proportional response to speed for each channel is inputted by the user.

The line scan camera technology anticipates a digital sensor 1-pixel width by a multitude of pixels tall. The digital sensor is assembled with a lens to complete a line scan camera assembly. The line scan technology requires the target to move in front of the sensor to produce an image by repeatedly triggering the single pixel to capture the new information of the target in front of the line scan camera assembly. Each trigger results in a corresponding 1 pixel wide by an established multitude of pixels tall frame. Each frame is digitally transferred off the camera to a secondary processing system where each successive frame is stitched together to develop an image infinite width by the established pixel height. The line scan image is deliberately sectioned into images of defined width based on the parameters of the separate processing system.

In area scan technology, on the other hand, the sensor is a defined number of pixels wide and high. The sensor is assembled with a lens to complete an area scan camera assembly. The acquisition of an area scan image of a designated sensor pixel height by pixel width is achieved by a single received trigger. Each image has a length and width determined by the sensor width and height. Area scan images do not require target motion to provide a valuable image.

The line scan and area scan cameras are designed to operate in all environmental conditions including infrared, visible, ultraviolet, and all other lighting conditions.

The frequency output of the Linear System are Pulse Width Modulation (PWM) signals to the cameras. PWM signals can vary in their voltage and duty cycles. One embodiment of this for this application is a 0-24V output voltage, a 33% duty cycle and output frequencies between minimum of 1 Hz and a maximum of 300,000 Hz on each output channel based on the Speed of the Train and proportional user variables in the configuration. The output frequencies are established by the design of the computational device, integrated circuitry, and the input requirements of the cameras.

### BRIEF DESCRIPTION OF THE DRAWINGS

FIG. 1 is a perspective view of the portal image from the rail inspection portal.

FIG. 2 is a depiction of the rails with the wheels on the rails and the axle

FIG. 3 is a top view of the rails with the speed sensing device mounted to the rails. connecting the wheels with the speed sensing device mounted to the rail.

FIG. 4 is a representation of the components of the device

### NUMBERING REFERENCES

5 Firmware
10 Computational Device
15 Image Acquisition Devices
16 Line Scan Cameras
17 Area Scan Cameras
20 Network Communications
25 Analog Wheel Detection Device
26 Digital Speed Sensor
30 Train Wheel
35 Train Wheel Flange
36 Axle
40 Illumination
45 Rail
50 Speed Measuring Device
65 Portal
70 Triggering Output Frequency

### DETAILED DESCRIPTION OF THE EMBODIMENTS

It is imperative that the condition of the train be monitored as closely as possible during the travel of the train regardless of the location of the train. A failure of a piece or component on the train can lead to catastrophic results i.e. derailment that can lead to the loss of life and destruction of property with the attendant inability of other trains to travel on the tracks.

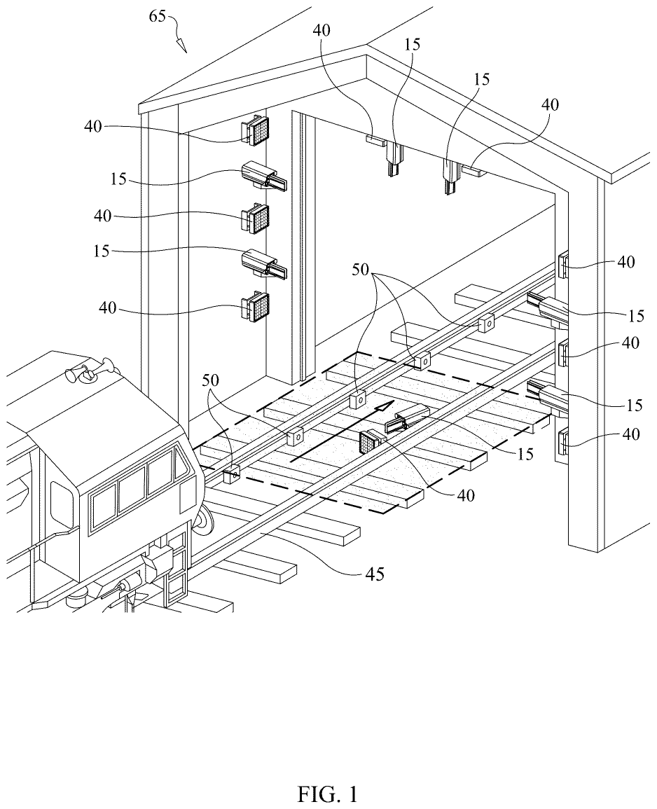

Large structures, which are called portals 65, as shown in FIG. 1, are erected over the rails through with the train will pass. These portals allow the train to pass unfettered as it moves along the tracks without a reduction in speed. When the train moves through these portals images of the train are captured in real time using the current technology. The portal has a multitude of Image Acquisition Devices 15 and Illumination 40 organized into modules. Each module is designed with a specific image perspective and target intent. These modules are arranged to image the top, sides, and underneath the train as the train passes through the portal, providing a conceptual 360° view, tangent to direction of travel.

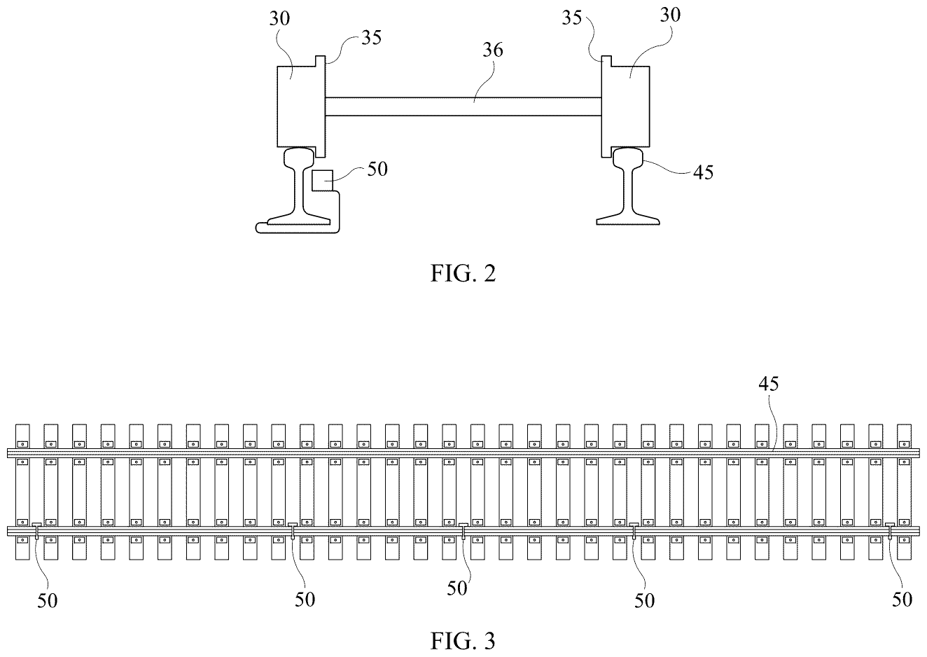

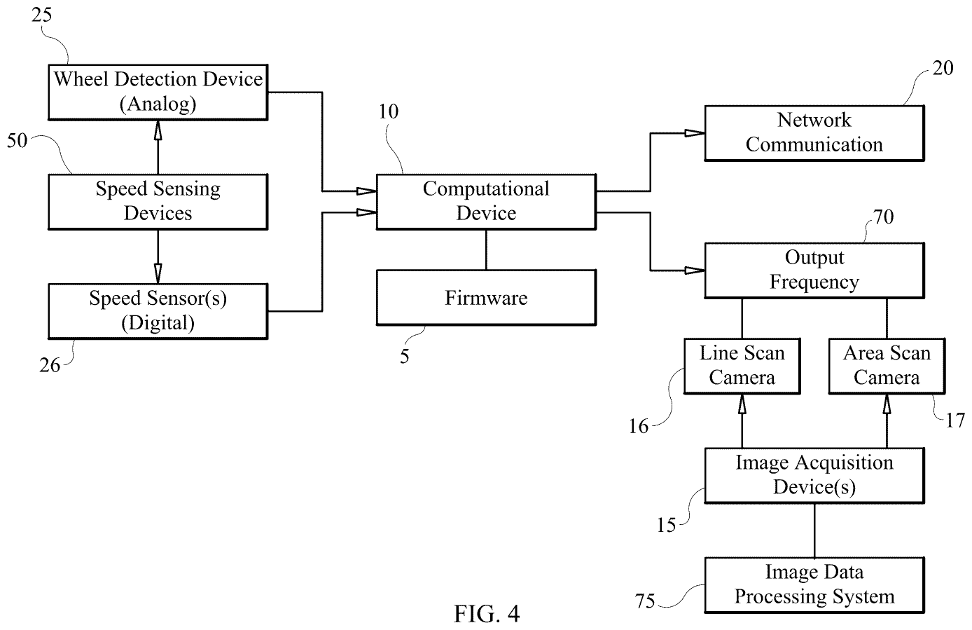

Trains, which are an accumulation of many different individual cars travel on a set of parallel tracks or rails 45. The wheel of a train 30 rests on each of the rails 45 and an axle 36 connects the train wheels, as shown in FIG. 2. As the train moves along the rails 45 the speed of the train is established by the operator based on operating rules and environmental conditions. The train may be at constant speed, accelerating, or decelerating at any time based on these operator's requirements for safe train handling. This applies to urban passenger train services as well as rural freight or long haul passenger services.

FIG. 3 depicts one embodiment with the placement of a plurality of Speed Sensing Devices 50 that are placed on the rails. The system will operate with a single Speed Sensing Devices 50 or can operate with multiple Speed Sensing Devices 50.

Analog Wheel Detection Devices 25 are commonly used in this industry and not developed by the applicant but used as part of the device. Analog Wheel Detection Devices 25 are connected to the Computational Device 10 to provide analog signals from which a speed value is computed by the Computational Device 10.

Digital Speed Sensors 27 are commonly used in this industry and not developed by the applicant but used as part of the device. The Digital Speed Sensors 27 are connected to the Computational Device 10 to provide a speed value as part of a digital communication.

For each of the analog or digital signals received by Computational Device 10 integrated Firmware 5 will issue a corresponding Network Communication 20. The Network Communication 20 signal is interpreted by a secondary processing system to initiate operations for the components of the Portal system: illumination means or lights 40, and Image Data Processing systems 75. For each of the Analog Wheel Detection Device 25 signals received by the Computational Device 10, integrated Firmware 5 will calculate the speed value of the train. Digital Speed Sensor signals received by the Computational Device 10, are stored as speed values by the Firmware 5. Every Speed value that is processed by the Firmware 5 will initiate a new set of Triggering output Frequency 70 for each channel based on the user defined settings of the Firmware 5. Hardwire connections are made between the specific Computational Device 10 output channels to the designated Image Acquisition Devices 15 to capture the high resolution images the moving train as it moves on the rails of the tracks The Triggering Output Frequencies 70 are Pulse Width Modulation (PWM) signals. PWM signals can vary in their voltage and duty cycles. One embodiment of this for this application is a 0-24V output voltage and a 33% duty cycle. The PWM configuration can be designed to support the signal requirements of the Image Acquisition devices 15. Triggering Output Frequencies 70 are outputs between a minimum of 1 Hz and a maximum of 300,000 Hz on each output channel based on the Speed of the Train and proportional user variables in the configuration. Two types of image acquisition device i.e. cameras 15 may be used: line scan cameras 16 or area scan cameras 17. A line scan camera 16 will capture an image of approximately 1 pixel in width and multiple pixels in height. The lines can images from the cameras are stitched to form a complete image of established height by theoretical infinite length. Area scan cameras will capture an image defined by the sensor pixel Height and Width. The choice of the type of camera is established by the target requirements and module implementation.

A computational device 10 controls the triggering output frequency 70 of the array of cameras 15 to achieve proportional images of the moving train as it moves along the set of tracks. The proportional relationship of the speed to the output of triggers describes the system function as a speed proportional triggering. An image generated by a Line Scan Cameras 16 that is not triggered in a proportional manner to the target speed or with incorrect settings, will be distorted and not accurately represent the target. Images generated by Area Scan Cameras 17, can be large and can utilize significant Image Data Processing 75 resources. Using speed Proportional triggering ensures a specific target is imaged an appropriate number of times, allowing for an efficient sizing of Image Data Processing 75 system. The alternative with Area Scan Cameras 17, is a constant trigger rate, which if not appropriately established, can overload the Image Data Processing 75 resources at slow train speeds or not capturing the target at High train speeds.

1. The inventors claim a method and apparatus for the accurate linear speed measurement of train speed and output of measured speed proportional camera trigger frequencies for the capture of high-resolution images of a moving train which is comprised of:
a speed sensing device;
a computational device;
analog input;
digital input;
network communication;
firmware;
analog pulse width modulation Output;
image acquisition devices; and
illumination.

2. A method and apparatus for the accurate linear speed measurement of train speed and the capture of high-resolution images of a moving train and output of measured speed proportional camera trigger frequencies for the capture of high-resolution images of a moving train as described in claim 1 wherein the image acquisition device is a line scan camera.

3. A method and apparatus for the accurate linear speed measurement of train speed and output of proportional camera trigger frequencies for the capture of high-resolution images of a moving train described in claim 1 wherein the image acquisition device is an area scan camera.

4. A method and apparatus for the accurate linear speed measurement of train speed and output of proportional camera trigger frequencies for the capture of high-resolution images of a moving train as described in claim 1 wherein the speed sensing device provides a digital output.

5. A method and apparatus for the accurate linear speed measurement of train speed and output of proportional camera trigger frequencies for the capture of high-resolution images of a moving train as described in claim 1 wherein the speed sensing device provides an analog output.

6. A method and apparatus for the accurate linear speed measurement of train speed and output of proportional camera trigger frequencies for the capture of high-resolution images of a moving train as described in claim 1 wherein the Computational Device communicates with a central system for control operations and image processing.

7. A method and apparatus for the accurate linear speed measurement of train speed and output of proportional camera trigger frequencies for the capture of high-resolution images of a moving train as described in claim 1 wherein the Computational Device outputs independent pulse width modulation frequencies on independent channels based on user established configurations for each of the independent channels.

8. A method and apparatus for the accurate linear speed measurement of train speed and output of proportional camera trigger frequencies for the capture of high-resolution images of a moving train as described in claim 1 wherein the Computational Device calculates the output frequency for the configured speed sensor resolution to include every new speed measurement input.
